(19) United States
(12) Patent Application Publication
(10) Pub. No.: US 2023/0289852 A1
(43) Pub. Date: Sep. 14, 2023

(54) Expert Platform System and Method

(71) Applicant: FitElephants LLC, Boston, MA (US)

(72) Inventors: Hercules G. Haseotes, Sudbury, MA (US); Glenn Hodgkinson, Cookeville, TN (US)

(21) Appl. No.: 18/183,725

(22) Filed: Mar. 14, 2023

Related U.S. Application Data
(60) Provisional application No. 63/319,722, filed on Mar. 14, 2022.

(51) Int. Cl. G06Q 30/02; G06Q 30/0282; G06Q 30/04

(52) U.S. Cl. CPC G06Q 30/0281; G06Q 30/0282; G06Q 30/04

(57) ABSTRACT

A computer-implemented method, computer program product and computing system for maintaining a expert platform that defines a plurality of experts, wherein each of the plurality of the expert defines a rate for an expert session; enabling a user to browse the expert platform to review one or more of the plurality of experts; effectuating an expert session between one of the plurality of experts and the user for a defined session rate; and effectuating the billing of the user for the defined session rate.

### RELATED APPLICATION(S)

This application claims the benefit of U.S. Provisional Application No(s). 63/319,722 filed on 14 Mar. 2022, the entire contents of which are incorporated herein by reference.

### TECHNICAL FIELD

This disclosure relates to expert platforms and, more particularly, to expert platforms that enable the scheduling of sessions with experts.

### BACKGROUND

Expert platforms are online platforms that connect users with experts in a particular field or industry. These platforms have their roots in the early days of the internet, when early adopters began using bulletin board systems and online forums to exchange information and expertise.

The first expert platform, called ExpertNet, was launched in 1996 by MCI Communications. It allowed customers to submit questions and receive answers from a network of experts in various fields. This was followed by other early expert platforms such as Keen.com (1999), JustAnswer (2003), and LivePerson (1995).

The rise of expert platforms can be attributed to several factors. First, the growth of the internet and the increasing availability of high-speed connectivity made it easier for people to connect with each other online. Second, the increasing complexity of certain industries and the growing demand for specialized knowledge made it more difficult for individuals to find answers to their questions or solutions to their problems. Finally, the emergence of a gig economy and the increasing prevalence of remote work created new opportunities for experts to monetize their knowledge and expertise.

### SUMMARY OF DISCLOSURE

In one implementation, a computer-implemented method is executed on a computing device and includes: maintaining an expert platform that defines a plurality of experts, wherein each of the plurality of the expert defines a rate for an expert session; enabling a user to browse the expert platform to review one or more of the plurality of experts; effectuating an expert session between one of the plurality of experts and the user for a defined session rate; and effectuating the billing of the user for the defined session rate.

One or more of the following features may be included. Effectuating an expert session between one of the plurality of experts and the user for a defined session rate may include: effectuating the expert session between one of the plurality of experts and the user for a defined session rate immediately. Effectuating an expert session between one of the plurality of experts and the user for a defined session rate may include: effectuating the expert session between one of the plurality of experts and the user for a defined session rate in the future. Effectuating an expert session between one of the plurality of experts and the user for a defined session rate may include: effectuating a prerecorded expert session between one of the plurality of experts and the user for a defined session rate. Effectuating an expert session between one of the plurality of experts and the user for a defined session rate may include: effectuating a live remote expert session between one of the plurality of experts and the user for a defined session rate. Effectuating an expert session between one of the plurality of experts and the user for a defined session rate may include: effectuating a live in-person expert session between one of the plurality of experts and the user for a defined session rate. Effectuating the billing of the user for the defined session rate may include: charging a credit card of the user for the defined session rate. The user may be enabled to review the expert and/or expert session. The user may be enabled to provide feedback concerning the expert and/or expert session. The plurality of experts may be enabled to post content on the expert platform.

In another implementation, a computer program product resides on a computer readable medium and has a plurality of instructions stored on it. When executed by a processor, the instructions cause the processor to perform operations including maintaining an expert platform that defines a plurality of experts, wherein each of the plurality of the expert defines a rate for an expert session; enabling a user to browse the expert platform to review one or more of the plurality of experts; effectuating an expert session between one of the plurality of experts and the user for a defined session rate; and effectuating the billing of the user for the defined session rate.

One or more of the following features may be included. Effectuating an expert session between one of the plurality of experts and the user for a defined session rate may include: effectuating the expert session between one of the plurality of experts and the user for a defined session rate immediately. Effectuating an expert session between one of the plurality of experts and the user for a defined session rate may include: effectuating the expert session between one of the plurality of experts and the user for a defined session rate in the future. Effectuating an expert session between one of the plurality of experts and the user for a defined session rate may include: effectuating a prerecorded expert session between one of the plurality of experts and the user for a defined session rate. Effectuating an expert session between one of the plurality of experts and the user for a defined session rate may include: effectuating a live remote expert session between one of the plurality of experts and the user for a defined session rate. Effectuating an expert session between one of the plurality of experts and the user for a defined session rate may include: effectuating a live in-person expert session between one of the plurality of experts and the user for a defined session rate. Effectuating the billing of the user for the defined session rate may include: charging a credit card of the user for the defined session rate. The user may be enabled to review the expert and/or expert session. The user may be enabled to provide feedback concerning the expert and/or expert session. The plurality of experts may be enabled to post content on the expert platform.

In another implementation, a computing system includes a processor and a memory system configured to perform operations including maintaining an expert platform that defines a plurality of experts, wherein each of the plurality of the expert defines a rate for an expert session; enabling a user to browse the expert platform to review one or more of the plurality of experts; effectuating an expert session between one of the plurality of experts and the user for a defined session rate; and effectuating the billing of the user for the defined session rate.

One or more of the following features may be included. Effectuating an expert session between one of the plurality of experts and the user for a defined session rate may include: effectuating the expert session between one of the plurality of experts and the user for a defined session rate immediately. Effectuating an expert session between one of the plurality of experts and the user for a defined session rate may include: effectuating the expert session between one of the plurality of experts and the user for a defined session rate in the future. Effectuating an expert session between one of the plurality of experts and the user for a defined session rate may include: effectuating a prerecorded expert session between one of the plurality of experts and the user for a defined session rate. Effectuating an expert session between one of the plurality of experts and the user for a defined session rate may include: effectuating a live remote expert session between one of the plurality of experts and the user for a defined session rate. Effectuating an expert session between one of the plurality of experts and the user for a defined session rate may include: effectuating a live in-person expert session between one of the plurality of experts and the user for a defined session rate. Effectuating the billing of the user for the defined session rate may include: charging a credit card of the user for the defined session rate. The user may be enabled to review the expert and/or expert session. The user may be enabled to provide feedback concerning the expert and/or expert session. The plurality of experts may be enabled to post content on the expert platform.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a expert platform process according to an embodiment of the present disclosure;

FIGS. 2-3 are diagrammatic views of an expert platform rendered by the expert platform process of FIG. 1 according to an embodiment of the present disclosure;

FIG. 4 is a flowchart of the expert platform process of FIG. 1 according to an embodiment of the present disclosure; and

FIG. 5 is a diagrammatic view of an expert platform rendered by the expert platform process of FIG. 1 according to an embodiment of the present disclosure.

Like reference symbols in the various drawings indicate like elements.

### DETAILED DESCRIPTION OF THE PREFERRED EMBODIMENTS

### System Overview

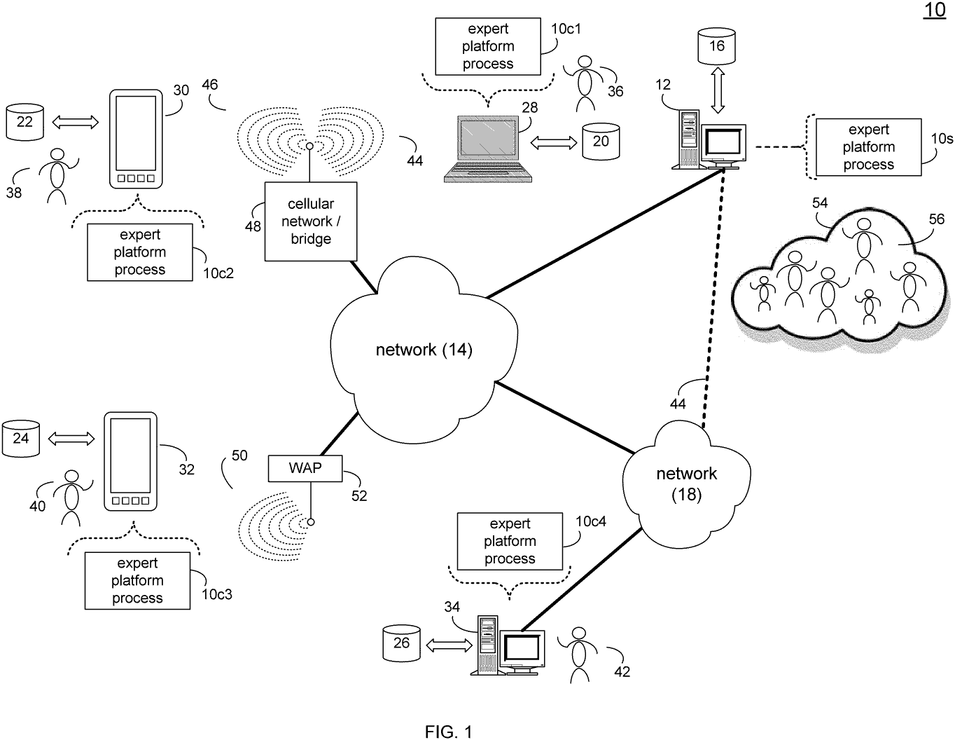

Referring to FIG. 1, there is shown expert platform process 10. Expert platform process 10 may be implemented as a server-side process, a client-side process, or a hybrid server-side / client-side process. For example, expert platform process 10 may be implemented as a purely server-side process via expert platform process 10s. Alternatively, expert platform process 10 may be implemented as a purely client-side process via one or more of expert platform process 10cl, expert platform process 10c2, expert platform process 10c3, and expert platform process 10c4. Alternatively still, expert platform process 10 may be implemented as a hybrid server-side / client-side process via expert platform process 10s in combination with one or more of expert platform process 10c1, expert platform process 10c2, expert platform process 10c3, and expert platform process 10c4. Accordingly, expert platform process 10 as used in this disclosure may include any combination of expert platform process 10s, expert platform process 10c1, expert platform process 10c2, expert platform process 10c3, and expert platform process 10c4.

Expert platform process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of expert platform process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of expert platform processes 10c1, 10c2, 10c3, 10c4 may include but are not limited to a web browser, a game console user interface, a mobile device user interface, or a specialized application (e.g., an application running on e.g., the Android™ platform, the iOS™t platform, the Windows™t platform, the Linux™ platform or the UNIX ™ platform). The instruction sets and subroutines of expert platform processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to a personal digital assistant (not shown), a tablet computer (not shown), laptop computer 28, smart phone 30, smart phone 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access expert platform process 10 directly through network 14 or through secondary network 18. Further, expert platform process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and smart phone 30 are shown wirelessly coupled to network 14 via wireless communication channels 44, 46 (respectively) established between laptop computer 28, smart phone 30 (respectively) and cellular network / bridge 48, which is shown directly coupled to network 14. Further, smart phone 32 is shown wirelessly coupled to network 14 via wireless communication channel 50 established between smart phone 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11 g, 802.11n, Wi-Fi, and/or Bluetooth device that is capable of establishing wireless communication channel 50 between smart phone 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

### Expert Platform

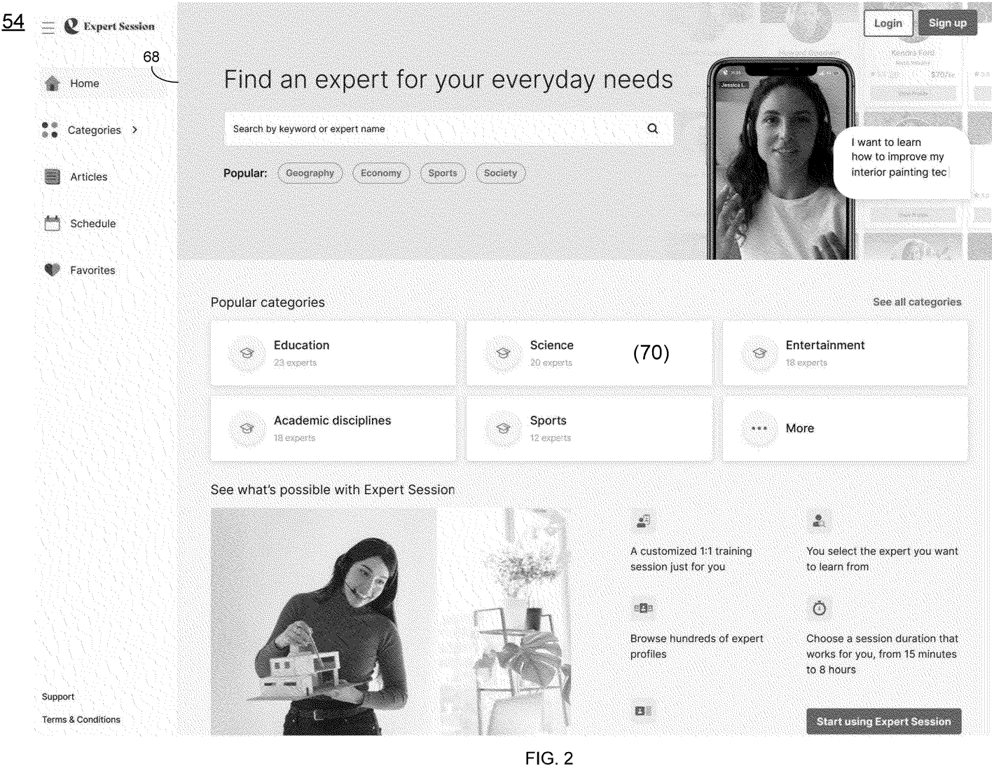

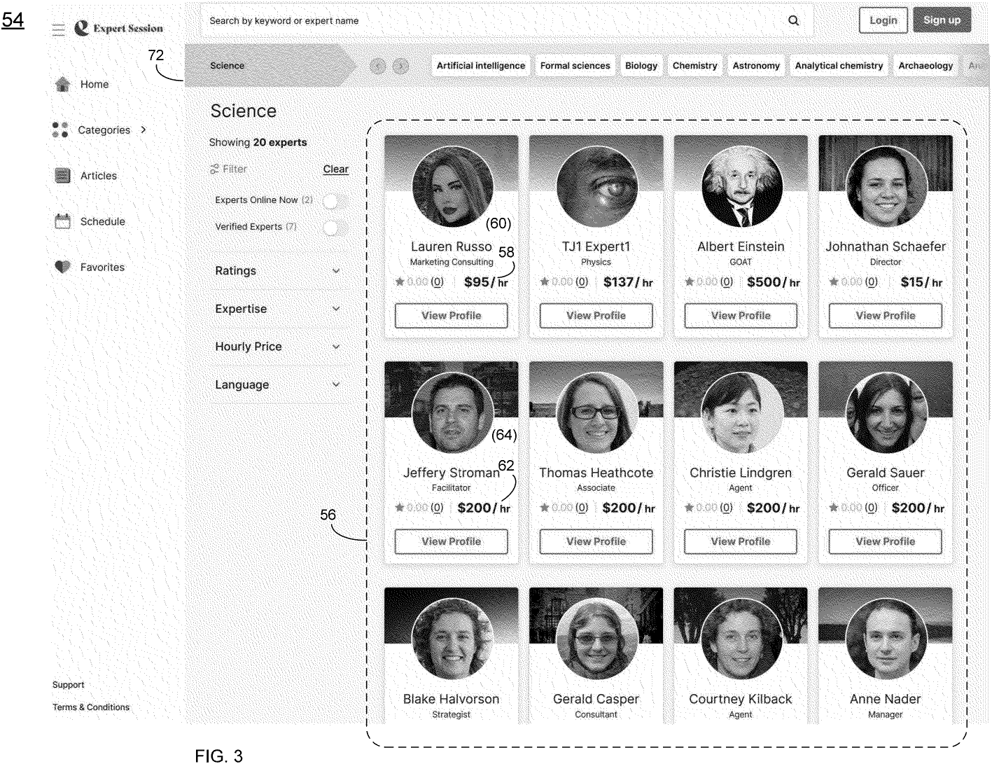

Referring also to FIGS. 2-3, there is shown expert platform 54. As is known in the art, an expert platform (e.g., expert platform 54) is an online platform that connects people with experts in a particular field or industry. These platforms typically provide a way for users to find and communicate with experts who can help them with specific questions or problems. Expert platforms (e.g., expert platform 54) can take various forms, ranging from simple question-and-answer forums to more sophisticated marketplaces that allow users to hire experts for specific projects or tasks. Some expert platforms are free to use, while others charge fees or commissions for connecting users with experts. Expert platforms (e.g., expert platform 54) have become increasingly popular in recent years as more people turn to the internet for information and solutions. These platforms offer a way for users to access specialized knowledge and expertise that may be difficult or expensive to find elsewhere. At the same time, they provide a way for experts to monetize their knowledge and build their reputations online.

### Expert Platform Process

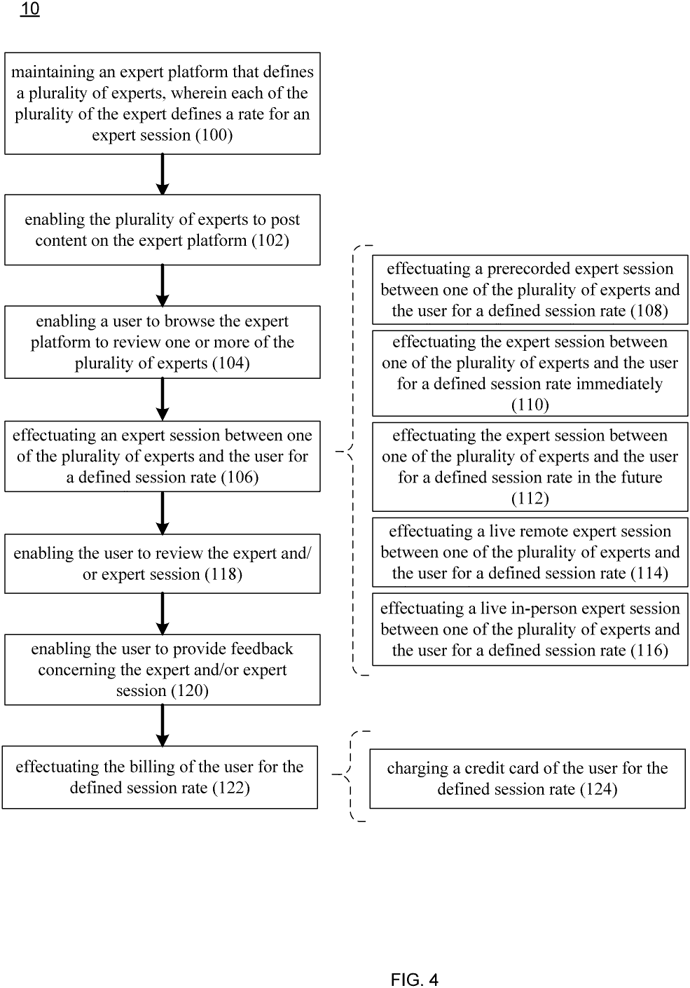

Referring also to FIG. 4, there is shown expert platform process 10 that may be configured to allow people / visitors to navigate and use expert platform 54. For example, expert platform process 10 may maintain 100 the expert platform (e.g., expert platform 54) that defines a plurality of experts (e.g., plurality of experts 56), wherein each of the plurality of the experts (e.g., plurality of experts 56) defines a rate for an expert session (e.g., rate 58 for expert 60, rate 62 for expert 64).

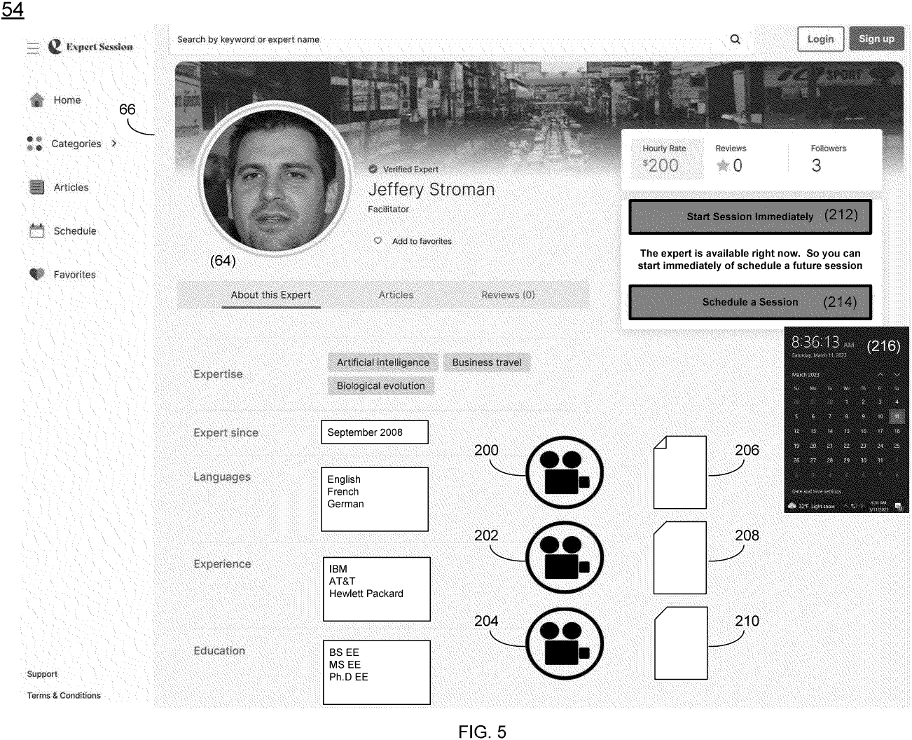

Referring also to FIG. 5, expert platform process 10 may enable 102 the plurality of experts (e.g., plurality of experts 56) to post content on the expert platform (e.g., expert platform 54). For example and within expert homepage 66 (e.g., an expert homepage for expert 64 i.e., Jeffery Stroman), expert 64 may post various videos (e.g., videos 200, 202, 204) and/or various pieces of content (e.g., content 206, 208, 210), which may provide examples of (and insight into) the types of expert services that may be provided by (in this example) expert 64. The videos (e.g., videos 200, 202, 204) and/or the content (e.g., content 206, 208, 210) may be hosted locally (e.g., within expert platform 54) or remotely (e.g., on YouTube for videos, Flicker for images, GoogleDocs for text, etc.).

Expert platform process 10 may enable 104 a user (e.g., user 40) to browse the expert platform (e.g., expert platform 54) to review one or more of the plurality of experts (e.g., plurality of experts 56). For example, assume that user 40 is looking for an artificial intelligence expert. Accordingly, expert platform process 10 may enable 104 user 40 to access the platform homepage (e.g., platform homepage 68) of expert platform 54 so that user 40 may browse the same. User 40 may then select “Science” category 70 (from the group of available categories), as “artificial intelligence” would fall within “Science” category 70.

In response to this selection, expert platform process 10 may render the science category homepage (e.g., science category homepage 72) of expert platform 54. User 40 may then review one or more of the plurality of experts (e.g., plurality of experts 56) defined on science category homepage 72 to identify an expert that meets their needs. Assume that user 40 is interested in expert 64. Accordingly, user 40 may then select expert 64 from plurality of experts 56, resulting in expert platform process 10 rendering the “Jeffrey Stroman” homepage (e.g., expert homepage 66) of expert platform 54

User 40 may then research expert 64 by reviewing the videos (e.g., video 200, 202, 204) and/or the content (e.g., content 206, 208, 210) associated with user 64. If expert 64 meets the needs of user 40, expert platform process 10 may effectuate 106 an expert session between one of the plurality of experts (e.g., plurality of experts 56) and the user (e.g., user 40) for a defined session rate. In the case of expert 64, that defined session rate is $200 per hour.

When effectuating 106 an expert session between one of the plurality of experts (e.g., plurality of experts 56) and the user (e.g., user 40) for a defined session rate, expert platform process 10 may:
effectuate 108 a prerecorded expert session between one of the plurality of experts (e.g., plurality of experts 56) and the user (e.g., user 40) for a defined session rate. In this particular example, user 40 may effectuate 108 a prerecorded expert session between expert 64 and user 40 for a rate of $200 per hour. In such a situation, user 40 may pay $200 per hour (or some other rate) to watch prerecorded videos that provide e.g., instructions concerning (in this example) various aspects of artificial intelligence.
effectuate 110 the expert session between one of the plurality of experts (e.g., plurality of experts 56) and the user (e.g., user 40) for a defined session rate immediately. In this particular example, user 40 may effectuate 110 an expert session that occurs immediately between expert 64 and user 40 for a rate of $200 per hour... assuming that both expert 64 and user 40 are currently available. In such a situation, user 40 may select “Start Session Immediately” button 212 for a rate of $200 per hour.
effectuate 112 the expert session between one of the plurality of experts (e.g., plurality of experts 56) and the user (e.g., user 40) for a defined session rate in the future. In this particular example, user 40 may effectuate 112 an expert session that occurs sometime in the future between expert 64 and user 40 for a rate of $200 per hour... assuming that one or both of expert 64 and user 40 are currently unavailable. In such a situation, user 40 may select “Schedule a Session” button 214 for a rate of $200 per hour. Expert platform process 10 may then render scheduling calendar 216 to enable the scheduling of an expert session that occurs sometime in the future between expert 64 and user 40 for a rate of $200 per hour

When effectuating 106 an expert session between one of the plurality of experts (e.g., plurality of experts 56) and the user (e.g., user 40) for a defined session rate, expert platform process 10 may:
effectuate 114 a live remote expert session between one of the plurality of experts (e.g., plurality of experts 56) and the user (e.g., user 40) for a defined session rate. In this particular example, user 40 may effectuate 114 a live remote expert session between expert 64 and user 40 for a rate of $200 per hour, wherein such a live remote expert session may occur via a video conferencing platform, such a Microsoft Teams™, Zoom™, etc.
effectuate 116 a live in-person expert session between one of the plurality of experts (e.g., plurality of experts 56) and the user (e.g., user 40) for a defined session rate. In this particular example, user 40 may effectuate 116 a live in-person expert session between expert 64 and user 40 for a rate of $200 per hour, wherein such a live in-person expert session may require additional expenses, such as travel, lodging, etc. Live in-person expert sessions may be more popular for physical tasks, such as servicing field equipment, plumbing repair, home repair, etc.

Expert platform process 10 may enable 118 the user (e.g., user 40) to review the expert (e.g., expert 64) and/or expert session. For example, expert platform process 10 may enable 118 user 40 to provide the expert 64 and/or the expert session with a traditional star rating (e.g., between zero and five stars).

Expert platform process 10 may enable 120 the user (e.g., user 40) to provide feedback concerning the expert and/or expert session. Further, expert platform process 10 may enable 120 user 40 to provide the expert 64 and/or the expert session with text-based feedback (e.g., between zero and five stars).

Expert platform process 10 may effectuate 122 the billing of the user (e.g., user 40) for the defined session rate. For example and when effectuating 122 the billing of the user (e.g., user 40) for the defined session rate, expert platform process 10 may charge 124 a credit card of the user (e.g., user 40) for the defined session rate. So if the expert session was 2 hours long at a rate of $200 per hour, expert platform process 10 may charge 124 a credit card of the user (e.g., user 40) for $400. The administrators of expert platform 54 may generate revenue by retaining of portion of these charges to cover overhead (e.g., 10%, 25%, etc.).

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network / a wide area network / the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer / special purpose computer / other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method executed on a computing device comprising:
maintaining an expert platform that defines a plurality of experts, wherein each of the plurality of the expert defines a rate for an expert session;
enabling a user to browse the expert platform to review one or more of the plurality of experts;
effectuating an expert session between one of the plurality of experts and the user for a defined session rate; and
effectuating the billing of the user for the defined session rate.

2. The computer-implemented method of claim 1 wherein effectuating an expert session between one of the plurality of experts and the user for a defined session rate includes:
effectuating the expert session between one of the plurality of experts and the user for a defined session rate immediately.

3. The computer-implemented method of claim 1 wherein effectuating an expert session between one of the plurality of experts and the user for a defined session rate includes:
effectuating the expert session between one of the plurality of experts and the user for a defined session rate in the future.

4. The computer-implemented method of claim 1 wherein effectuating an expert session between one of the plurality of experts and the user for a defined session rate includes:
effectuating a prerecorded expert session between one of the plurality of experts and the user for a defined session rate.

5. The computer-implemented method of claim 1 wherein effectuating an expert session between one of the plurality of experts and the user for a defined session rate includes:
effectuating a live remote expert session between one of the plurality of experts and the user for a defined session rate.

6. The computer-implemented method of claim 1 wherein effectuating an expert session between one of the plurality of experts and the user for a defined session rate includes:
effectuating a live in-person expert session between one of the plurality of experts and the user for a defined session rate.

7. The computer-implemented method of claim 1 wherein effectuating the billing of the user for the defined session rate includes:
charging a credit card of the user for the defined session rate.

8. The computer-implemented method of claim 1 further comprising:
enabling the user to review the expert and/or expert session.

9. The computer-implemented method of claim 1 further comprising:
enabling the user to provide feedback concerning the expert and/or expert session.

10. The computer-implemented method of claim 1 further comprising:
enabling the plurality of experts to post content on the expert platform.

11. A computer program product residing on a computer readable medium having a plurality of instructions stored thereon which, when executed by a processor, cause the processor to perform operations comprising:
maintaining an expert platform that defines a plurality of experts, wherein each of the plurality of the expert defines a rate for an expert session;
enabling a user to browse the expert platform to review one or more of the plurality of experts;
effectuating an expert session between one of the plurality of experts and the user for a defined session rate; and
effectuating the billing of the user for the defined session rate.

12. The computer program product of claim 11 wherein effectuating an expert session between one of the plurality of experts and the user for a defined session rate includes:
effectuating the expert session between one of the plurality of experts and the user for a defined session rate immediately.

13. The computer program product of claim 11 wherein effectuating an expert session between one of the plurality of experts and the user for a defined session rate includes:
effectuating the expert session between one of the plurality of experts and the user for a defined session rate in the future.

14. The computer program product of claim 11 wherein effectuating an expert session between one of the plurality of experts and the user for a defined session rate includes:
effectuating a prerecorded expert session between one of the plurality of experts and the user for a defined session rate.

15. The computer program product of claim 11 wherein effectuating an expert session between one of the plurality of experts and the user for a defined session rate includes:
effectuating a live remote expert session between one of the plurality of experts and the user for a defined session rate.

16. The computer program product of claim 11 wherein effectuating an expert session between one of the plurality of experts and the user for a defined session rate includes:
effectuating a live in-person expert session between one of the plurality of experts and the user for a defined session rate.

17. The computer program product of claim 11 wherein effectuating the billing of the user for the defined session rate includes:
charging a credit card of the user for the defined session rate.

18. The computer program product of claim 11 further comprising:
enabling the user to review the expert and/or expert session.

19. The computer program product of claim 11 further comprising:
enabling the user to provide feedback concerning the expert and/or expert session.

20. The computer program product of claim 11 further comprising:
enabling the plurality of experts to post content on the expert platform.

21. A computing system including a processor and memory configured to perform operations comprising:
maintaining an expert platform that defines a plurality of experts, wherein each of the plurality of the expert defines a rate for an expert session;
enabling a user to browse the expert platform to review one or more of the plurality of experts;
effectuating an expert session between one of the plurality of experts and the user for a defined session rate; and
effectuating the billing of the user for the defined session rate.

22. The computing system of claim 21 wherein effectuating an expert session between one of the plurality of experts and the user for a defined session rate includes:
effectuating the expert session between one of the plurality of experts and the user for a defined session rate immediately.

23. The computing system of claim 21 wherein effectuating an expert session between one of the plurality of experts and the user for a defined session rate includes:
effectuating the expert session between one of the plurality of experts and the user for a defined session rate in the future.

24. The computing system of claim 21 wherein effectuating an expert session between one of the plurality of experts and the user for a defined session rate includes:
effectuating a prerecorded expert session between one of the plurality of experts and the user for a defined session rate.

25. The computing system of claim 21 wherein effectuating an expert session between one of the plurality of experts and the user for a defined session rate includes:
effectuating a live remote expert session between one of the plurality of experts and the user for a defined session rate.

26. The computing system of claim 21 wherein effectuating an expert session between one of the plurality of experts and the user for a defined session rate includes:
effectuating a live in-person expert session between one of the plurality of experts and the user for a defined session rate.

27. The computing system of claim 21 wherein effectuating the billing of the user for the defined session rate includes:
charging a credit card of the user for the defined session rate.

28. The computing system of claim 21 further comprising:
enabling the user to review the expert and/or expert session.

29. The computing system of claim 21 further comprising:
enabling the user to provide feedback concerning the expert and/or expert session.

30. The computing system of claim 21 further comprising:
enabling the plurality of experts to post content on the expert platform.
